(19) United States
(12) Patent Application Publication
(10) Pub. No.: US 2015/0024345 A1
(43) Pub. Date: Jan. 22, 2015

(54) A MILLING BLANK AND A METHOD FOR FABRICATING DENTAL BRIDGEWORK USING MILLING BLANK

(71) Applicants: Reza Eftekhar Ashtiani, Pacific PLSDS, CA (US); Arya EFTEKHAR ASHTIANI, Victoria (CA)

(72) Inventors: Reza Eftekhar Ashtiani, Pacific PLSDS, CA (US); Arya EFTEKHAR ASHTIANI, Victoria (CA)

(21) Appl. No.: 14/511,118

(22) Filed: Oct. 9, 2014

(51) Int. Cl. A61C 13/00; A61C 5/10; A61C 9/00

(52) U.S. Cl. CPC A61C 13/0022; A61C 13/0004; A61C 9/004; A61C 5/10
USPC 433/202.1; 428/542.8

(57) ABSTRACT

The various embodiments herein provide a dental mill blank for fabrication of dental appliance and restorations. A method for fabricating dental bridgework from the mill blank is also provided. The mill blank comprises a hard inner core and wherein the hard inner core provides resistance against a normal occlusal force, a soft outer cover surrounding the inner core, a channel passing through the inner core and the outer cover, a metallic abutment provided at one end of the channel and a handle stud for holding the mill blank onto a milling machine. The channel is designed to make a screw type bridgework for supporting a plurality of neighbouring implants.

### CROSS-REFERENCE TO RELATED APPLICATIONS

The present application claims the benefit and the priority of the U.S. Provisional Patent Application with Ser. No. 61/928,885 and entitled, “MILLING BLANK WITH CENTRAL HARD CORE FOR BRIDGEWORK DESIGN AND METHODS”, filed on Jan. 17, 2014, the content of which is incorporated in entirety by reference herein.

### BACKGROUND

1. Technical Field

The embodiments herein generally relates to medical systems and methods. The embodiments herein particularly relates to a dental restoration systems and methods. The embodiments herein more particularly relates to a milling blank for dental applications and a method for fabricating a dental bridgework using the milling blank.

2. Description of the Related Art

The art of fabricating custom fit bridgework or fixed partial denture in the dental field is well known. This prosthesis is a replacement of the lost teeth with a help of an adjoining teeth. For the fabrication of this restoration, the dentist prepare the neighboring teeth for receiving a crown or cap named “Retainer” which holds an artificial crown for a lost tooth which named “Pontic”. The connection of the panties to the retainer is named “joint”. This bridgework must undergo the occlusal force. The bridgework is fabricated routinely in dental laboratory by using hard materials like dental alloys or hard ceramics with or without a super facial layering. Mostly these procedures need more than two sessions to finish. First an impression is taken of the dentition using the suitable materials and a model is made to replicate a patient dentition after a tooth preparation. The prosthesis is then produced on the model by metal, ceramic or other suitable materials. A series of steps for proper fit and comfort is followed. Thus, the fabrication of custom prosthesis involves intensive labor, high degree of skills and longer time periods.

In recent years, the technological advances have provided a computer automated machinery for fabricating the prosthesis with minimal human labor and reduced working time. This technology, which is a combination of computer automation, optics, digitized equipment, CAD/CAM (computer-aided design I computer aided machining) and mechanical milling tools, is referred to “Digital Dentistry”. This proceed can produces dental prostheses by cutting, milling and grinding the dental materials to make a near exact shape of a dental restoration with a much more speed and a lower labor work than the conventional restoration.

The U.S. Pat. Nos. 4,837,732 and 4,575,805 and 4,776,704 disclose CAD/CAM technology for making the dental prostheses. Using the CAD/CAM for fabrication of dental prostheses involves a use of a “mill blank”, which is a solid piece of material from which, the prosthesis is cut. The currently available mill blanks, are made up of a two-pieces construction that comprises a support stub section and a milling blank section (for example U.S. Pat. Nos. 6,627,327 and 4,615,678). The stub section is adapted to fit into a collect chuck of the milling machine and the prostheses is milled by a bur from the milling section.

Some of the CAD/CAM machines are designed to use as chair side in dental office, for example, Cerec machine by Sirona or E4D machine by E4D technologies and some of them used in dental laboratories. The chair side systems have the benefit of same day delivery but the milling unit is not suitable to works on very hard materials. So the usage of chair side machine is limited mostly to the single unit or intra-coronal restoration. For making the posterior bridgeworks, the laboratory CAD/CAM is employed which need more than one session to be completed.

The physical properties, such as hardness and brittleness, of the currently used dental porcelain materials limit the usefulness of this material without a substructure for crown and bridge. So a metal or hard ceramic used as support of this brittle material in routine dentistry.

Chair side CAD/CAM is unable to shape very hard material easily. So the use of this device is limited to softer or presenter ceramic and porcelain which could not be in high pressure situation such as long span bridge in anterior or posterior of the mouth, short span bridge in posterior area, short teeth or even anterior bridge. The oral condition does not let the long span bridge and the short span bridge, to have a joint diameter of less than 16 mm². Therefore the use of the device is only limited to inlay, onlay, single crown and short span bridge of anterior teeth, if only the tooth crown is long enough to let a bridge work have a joint diameter of 16 mm².

Hence there is a need for a mill blank which is used for fabricating a bridge which resists a normal occlusive force and with a reduced diameter for joint area. Further there is a need for a mill blank to provide a screw type bridge work for supporting a plurality of neighboring implants. Still further there is a need for a mill blank with bridgework having the orientation features.

The above mentioned shortcomings, disadvantages and problems are addressed herein and which will be understood by reading and studying the following work specification.

### OBJECTS OF THE EMBODIMENTS

The primary object of the embodiments herein is to provide a mill blank for dental applications a method for fabricating dental bridgework using the mill blank.

Another object of the embodiments herein is to provide a dental restoration in digital format.

Yet another object of the embodiments herein is to provide a mill blank with dental bridgework having enough resistance for normal oral pressure or occlusal force.

Yet another object of the embodiments herein is to provide a mill blank with dental bridgework with a surface area of joint less than 16 mm².

Yet another object of the embodiments herein is to provide a mill blank with outer cover made up of sintered or pre-sintered ceramics, composite or acrylic materials.

Yet another object of the embodiments herein is to provide a mill blank with a screw type bridge work for multiple neighboring implants.

Yet another embodiment of the present invention is to provide a method of fabricating a dental restoration and bridgework by adopting CAD/CAM techniques.

Yet another object of the embodiments herein is to provide a mill blank for use in the fabrication of dental appliance and restorations.

These and other objects and advantages of the present invention will become readily apparent from the following detailed description taken in conjunction with the accompanying drawings.

### SUMMARY

The various embodiments herein provide a dental mill blank for fabrication of dental appliance and restorations. The mill blank comprises a hard inner core and wherein the hard inner core provides resistance against a normal occlusal force, a soft outer cover surrounding the inner core, a channel passing through the inner core and the outer cover, a metallic abutment provided at one end of the channel and a handle stud for holding the mill blank onto a milling machine. The channel is designed to make a screw type bridgework for supporting a plurality of neighboring implants.

According to one embodiment herein, the hard inner core has a surface provided with a surface bonding profile for establishing a connection between the inner core and the outer cover.

According to one embodiment herein, the hard inner core is designed in a plurality of shapes and sizes, and wherein a shape of the hard inner core is selected from a group consisting of a square, rectangular, triangular, rhomboidal, ovoid, cylindrical or irregular shape.

According to one embodiment herein, the hard inner core has an outline designed in a shape selected from a group consisting of a curve shape, bead shape, rectangular shape or irregular in shape.

According to one embodiment herein, the inner core has a projection at each end, and wherein the projection resides inside an occlusal extension of the proximal boxes of an abutment tooth.

According to one embodiment herein, the hard inner core is extended along a length of the mill blank.

According to one embodiment herein, the inner core is manufactured from a high strength material selected from a group consisting of ceramic, zirconium, yttrium, stabilized zircon, alumina, mixture of alumina and zirconia, Sialon materials.

According to one embodiment herein, the surrounding outer cover is manufactured from a group of materials comprising feldespathic porcelain, glass porcelain, glass ceramic, acrylic or composite materials.

According to one embodiment herein, the surrounding outer cover is made up of a sintered material.

According to one embodiment herein, the surrounding outer cover is made up of a hard material.

According to one embodiment herein, the surrounding outer cover is made up of a green material and wherein the green material is hardened after a milling process.

According to one embodiment herein, the hard inner cover and the soft outer cover comprise a plurality of layers.

According to one embodiment herein, the surrounding outer cover of the mill blank is designed to form a crown of the bridgework after a milling process, wherein the crown is cemented on an abutment tooth.

According to one embodiment herein, the handle stud comprises a mounting stud and a support stud, wherein the stud provides support the mill blank during a mounting of the mill blank onto the milling machine.

According to one embodiment herein, the channel is provided to attach a preformed implant abutment to the milling blank, and wherein the preformed implant abutment comprises a connection part, a base and a retentive part, and wherein the retentive part is an abutment screw.

The various embodiments herein provide a method for fabricating a dental bridgework from a mill blank. The method comprises the following steps. A digital surface representation of at least a portion of patient mouth comprising an edentulous area is acquired. The digital surface representation is acquired by scanning the geometry of the edentulous area of patient's mouth. A three-dimensional digital model of the bridgework is created from the digital surface representation. The digital model of the bridgework is designed from the digital surface representation using a CAD software. A dental mill blank suitable for the bridgework is selected. The mill blank is milled according to the three dimensional digital model to form the bridgework.

According to one embodiment herein, the step of selecting the mill blank depends on a preoperative condition of the mill blank and passivity of constructing the bridgework.

According to one embodiment herein, the preoperative condition of the mill blank is calculated via intraoral scanning or is manually calculated using a connector key or a hard core gauge.

According to one embodiment herein, adjustment of the abutment teeth and the bridgework is carried out until the abutment teeth is correctly fit into a patient's mouth.

According to one embodiment herein, the milling of the mill blank is performed by a milling machine using CAM.

The various embodiments herein provide a dental mill blank. The mill blank comprises a hard inner core which provides resistance against a normal occlusal force, a soft outer cover surrounding the inner core, and a handle stud for holding the mill blank onto a milling machine.

According to one embodiment herein, the hard inner core is varied in terms of shape and size. The inner core is curve shaped, bead shaped, rectangular shaped or irregular in shape.

According to one embodiment herein, the hard inner core comprises a surface bonding for providing a connection between the inner core and the outer cover.

According to one embodiment herein, the inner core has a projection on each end, and the projection resides inside an occlusal extension of the proximal boxes of the abutment teeth.

According to one embodiment herein, the hard inner cover is extended along the length of the mill blank.

According to one embodiment herein, the inner core is manufactured from a group of high strength materials comprising ceramic, zirconium, yttrium, stabilized zircon, alumina, mixture of alumina and zirconia, Sialon materials.

According to one embodiment herein, the surrounding outer cover is manufactured from a group of materials comprising feldespathic porcelain, glass porcelain, glass ceramic, acrylic materials.

According to one embodiment herein, the hard inner cover and the soft outer cover comprise a multiple layers of materials.

According to one embodiment herein, the surrounding outer cover of the mill blank is grinded by a milling machine to form a crown of the bridgework and the crown is cemented on an abutment tooth.

According to one embodiment herein, the handle stud comprises a mounting stud and a support stud, and the stud provides support during mounting of the mill blank onto the milling machine.

According to another embodiment herein, the mill blank further comprises a channel which passes through the surrounding outer cover and the inner hard core, and the channel is provided to attach a preformed implant abutment to the milling blank.

According to one embodiment herein, the channel provides a screw type bridgework restoration for multiple neighboring implant abutments.

According to one embodiment herein, the preformed implant abutment comprises a connection part, a base and a retentive part such as an abutment screw.

The various embodiments herein provide a method for fabricating dental bridgework from a mill blank. The method comprises the following steps. A digital surface representation of at least a portion of patient mouth comprising an edentulous area is acquired. Based on the digital surface representation of the edentulous area, a three-dimensional digital model of the bridgework is created. Further the dental mill blank suitable for the bridgework is selected. The bridgework is fabricated by milling the mill blank according to the three dimensional digital model.

According to one embodiment herein, the digital surface representation is acquired by scanning the geometry of the edentulous area of patient's mouth;

According to one embodiment herein, the digital model of the bridgework is designed from the digital surface representation using CAD software.

According to one embodiment herein, the selection of the mill blank depends on a preoperative condition of the mill blank and a passivity of constructing the bridgework.

According to one embodiment herein, the preoperative condition of the mill blank is calculated via intraoral scanning or is calculated manually using a connector key or a hard core gauge.

According to one embodiment herein, an adjustment of the abutment teeth and the bridgework is carried out until the abutment teeth are correctly fit into a patient's mouth.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a perspective view of a typical mill blank, according to an embodiment herein.

FIG. 2A, FIG. 2B and FIG. 2C illustrate a perspective view of the typical mill blank comprising different types of inner hard core, according to an embodiment herein.

FIG. 3A illustrates a perspective view of the typical mill blank comprising an inner hard core with a projection on each end, according to an embodiment herein.

FIG. 3B illustrates an arrangement of the projection present at the top edge surface of the inner core and provided at each end of the inner core, according to an embodiment herein.

FIG. 3C illustrates an arrangement of the projection present and extended at the middle of the inner core, according to an embodiment herein.

FIG. 4 illustrates a perspective view of the typical mill blank comprising an inner hard core which extends along the length of the mill blank, according to an embodiment herein.

FIG. 5A and FIG. 5B illustrate a schematic view of an abutment tooth present around an edentulous area from occlusal view, according to an embodiment herein.

FIG. 5C and FIG. 5D illustrate a schematic view of an abutment tooth present around an edentulous area from buccal view, according to an embodiment herein.

FIG. 6A and FIG. 6B illustrate a perspective view of the bridgework constructed from the mill blank, according to an embodiment herein.

FIG. 7 illustrates a perspective view of the mill blank with a channel at one end of the blank, according to an embodiment herein.

FIG. 8 illustrates a schematic view of a preformed implant abutment, according to an embodiment herein.

FIG. 9 illustrates a flowchart indicating a method for fabricating the bridgework from the mill blank, according to an embodiment herein.

FIG. 10 illustrates a flowchart indicating the detailed fabrication process of the bridgework, according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a dental mill blank structure and a method for fabricating dental bridgework from the mill blank. The mill blank is a solid structural block used in dental restoration. A crown is a cover or “caps” for a tooth to restore it to its normal shape and size thus strengthening and improving the appearance of a tooth. A bridge is a dental appliance that replaces one or more natural missing teeth, thereby “bridging” the space between two teeth. The bridges are cemented to the natural teeth or implants surrounding on either side of the empty space. These teeth, called abutments, serve as anchors for the bridge. A replacement tooth, called a pontic, is attached to the crowns that cover the abutments. The crown or the bridge is constructed from the mill blank by using subtractive milling.

The various embodiments herein provide a dental mill blank for fabrication of dental appliance and restorations. The mill blank comprises a hard inner core and wherein the hard inner core provides resistance against a normal occlusal force, a soft outer cover surrounding the inner core, a channel passing through the inner core and the outer cover, a metallic abutment provided at one end of the channel and a handle stud for holding the mill blank onto a milling machine. The channel is designed to make a screw type bridgework for supporting a plurality of neighboring implants.

According to one embodiment herein, the hard inner core has a surface provided with a surface bonding profile for establishing a connection between the inner core and the outer cover.

According to one embodiment herein, the hard inner core is designed in a plurality of shapes and sizes, and wherein a shape of the hard inner core is selected from a group consisting of a square, rectangular, triangular, rhomboidal, ovoid, cylindrical or irregular shape.

According to one embodiment herein, the hard inner core has an outline designed in a shape selected from a group consisting of a curve shape, bead shape, rectangular shape or irregular in shape.

According to one embodiment herein, the inner core has a projection at each end, and wherein the projection resides inside an occlusal extension of the proximal boxes of an abutment tooth.

According to one embodiment herein, the hard inner core is extended along a length of the mill blank.

According to one embodiment herein, the inner core is manufactured from a high strength material selected from a group consisting of ceramic, zirconium, yttrium, stabilized zircon, alumina, mixture of alumina and zirconia, Sialon materials.

According to one embodiment herein, the surrounding outer cover is manufactured from a group of materials comprising feldespathic porcelain, glass porcelain, glass ceramic, acrylic or composite materials.

According to one embodiment herein, the surrounding outer cover is made up of a sintered material.

According to one embodiment herein, the surrounding outer cover is made up of a hard material.

According to one embodiment herein, the surrounding outer cover is made up of a green material and wherein the green material is hardened after a milling process.

According to one embodiment herein, the hard inner cover and the soft outer cover comprise a plurality of layers.

According to one embodiment herein, the surrounding outer cover of the mill blank is designed to form a crown of the bridgework after a milling process, wherein the crown is cemented on an abutment tooth.

According to one embodiment herein, the handle stud comprises a mounting stud and a support stud, wherein the stud provides support the mill blank during a mounting of the mill blank onto the milling machine.

According to one embodiment herein, the channel is provided to attach a preformed implant abutment to the milling blank, and wherein the preformed implant abutment comprises a connection part, a base and a retentive part, and wherein the retentive part is an abutment screw.

The various embodiments herein provide a method for fabricating a dental bridgework from a mill blank. The method comprises the following steps. A digital surface representation of at least a portion of patient mouth comprising an edentulous area is acquired. The digital surface representation is acquired by scanning the geometry of the edentulous area of patient's mouth. A three-dimensional digital model of the bridgework is created from the digital surface representation. The digital model of the bridgework is designed from the digital surface representation using a CAD software. A dental mill blank suitable for the bridgework is selected. The mill blank is milled according to the three dimensional digital model to form the bridgework.

According to one embodiment herein, the step of selecting the mill blank depends on a preoperative condition of the mill blank and passivity of constructing the bridgework.

According to one embodiment herein, the preoperative condition of the mill blank is calculated via intraoral scanning or is manually calculated using a connector key or a hard core gauge.

According to one embodiment herein, adjustment of the abutment teeth and the bridgework is carried out until the abutment teeth are correctly fit into a patient's mouth.

According to one embodiment herein, the milling of the mill blank is performed by a milling machine using CAM.

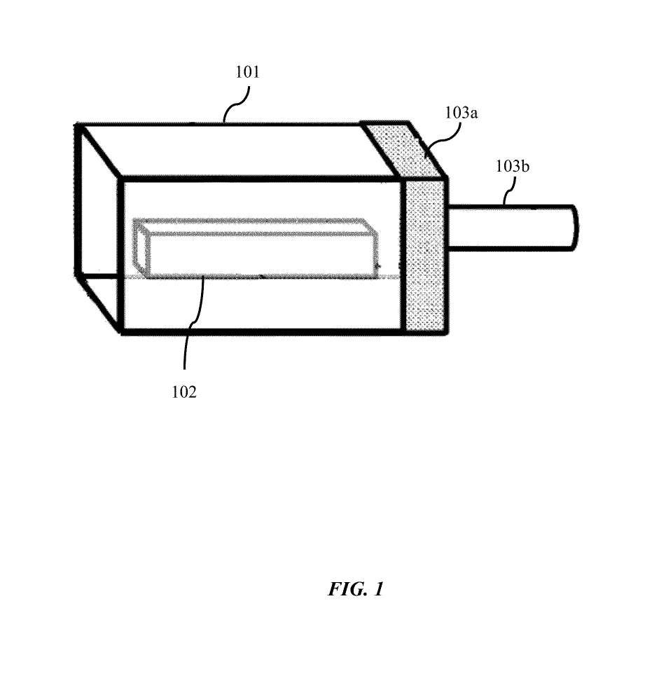

FIG. 1 illustrates a perspective view of a mill blank, according to an embodiment herein. The mil blank comprises of a hard inner core 101, a soft outer cover 102 surrounding the inner core 101, and a handle stud 103 for holding the mill blank onto a milling machine. The inner core 101 of the mill blank is constructed from high strength material including but not limited to ceramic, zirconium, yttrium, stabilized zircon, alumina, mixture of alumina and zirconia, Sialon and the like. The materials used for constructing the inner core 101 must fulfill the following conditions. The material used must be suitable and acceptable for use in an oral environment. The material must have an adequate pressure tolerance of lower than 16 mm² in cross section and must provide suitable mechanical or chemical bond with the surrounding cover 102. The inner hardcore 101 varies in term of shape and size. The circumference of the inner core 101 is covered with the soft outer cover 102. The outer cover 102 is manufactured from composite materials including but not limited to feldespathic porcelain, glass porcelain, glass ceramic, acrylic and the like. The hard inner core 101 and the softer outer cover 102 are composed of multiple layers of materials. The inner core 101 comprises a surface bonding or treatment area for providing better connection between the inner core 101 and the surrounding outer cover 102. The mill blank further comprises a handle stud 103 which is provided in order to hold the mill blank onto a milling machine during the milling process. The handle stud 103 further comprises a mounting stud 103a and a support stud 103b. The support stud 103b is used to fix the mill blank into the milling machine and the mill blank is held in-place by the mounting stud 103a.

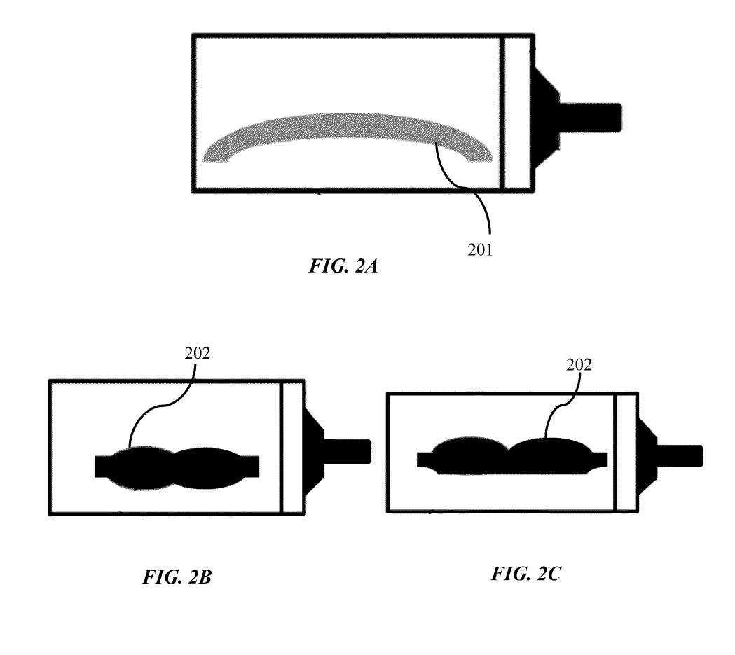

FIG. 2A, FIG. 2B and FIG. 2C illustrate the perspective views of the typical mill blank comprising different types of inner hard core, according to an embodiment of the present disclosure. The mill blank as shown in FIG. 2A comprises the inner core in curved shape 201. The mill blank shown in FIG. 2B comprises the inner core which has shape of a bead 202. The beads 202 are designed to be placed in the pontic area of the bridgework, after milling. The use of bead shaped inner core 202 reduces the size of surrounding outer cover and increases facture resistance of the bridgework. The mill blank with the bead shaped inner core 202 is shown from a different angle in FIG. 2C. Further the mill blank comprising the inner core and the outer cover can be of any shape including but not limited to square, rectangular, triangular, rhomboidal, ovoidal, and cylindrical shapes. The inner hard core of milling blank has a 3-point fracture strength exceeding 250 MPa.

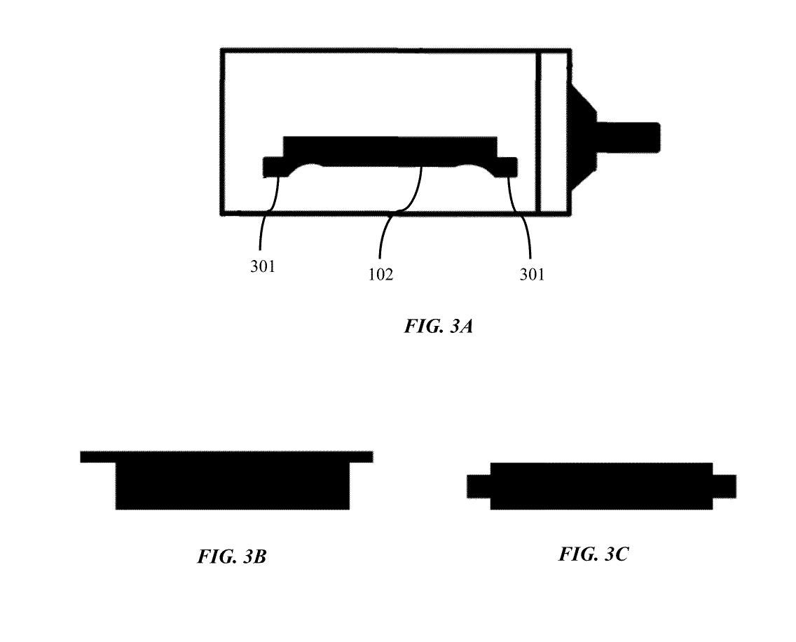

FIG. 3A illustrates a perspective view the typical mill blank comprising an inner hard core 102 with a projection 301 on each end, according to an embodiment herein. FIG. 3B and FIG. 3C illustrates the various arrangements of the projection 301 on each end of the inner core 102, according to an embodiment herein. The projection 301 is either present at the top edge surface of the inner core 102, or the projection 301 is extended at the middle of the inner core 102. The projection 301 is designed to position the inner core 102 into an occlusal extension of abutment teeth and thus reinforcing the bridgework.

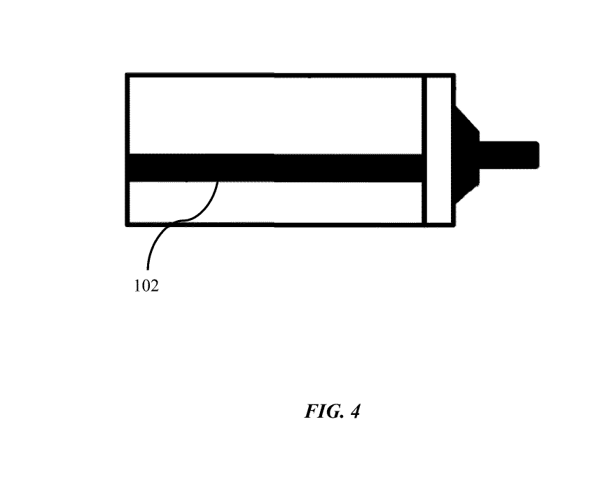

FIG. 4 illustrates a perspective view of the typical mill blank comprising an inner hard core 102 which extends along the length of the mill blank, according to an embodiment herein. The milling machine also carves out the hard inner core of the mill blank, according to the bridgework requirement.

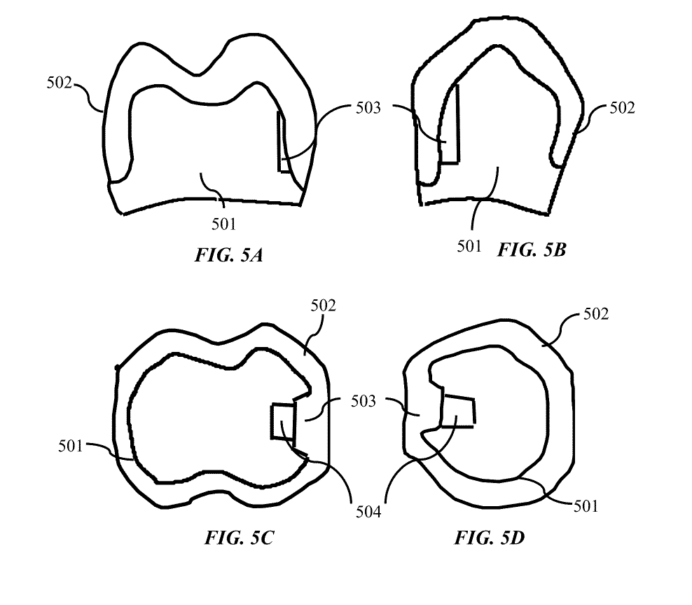

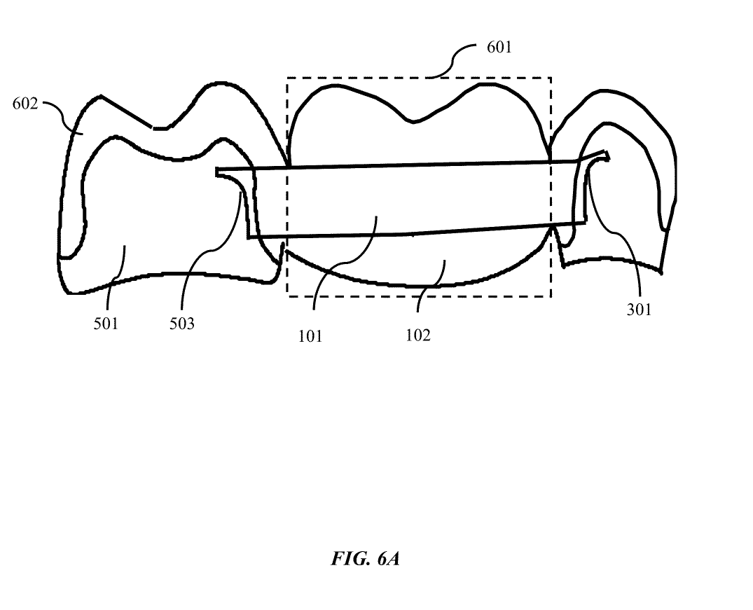

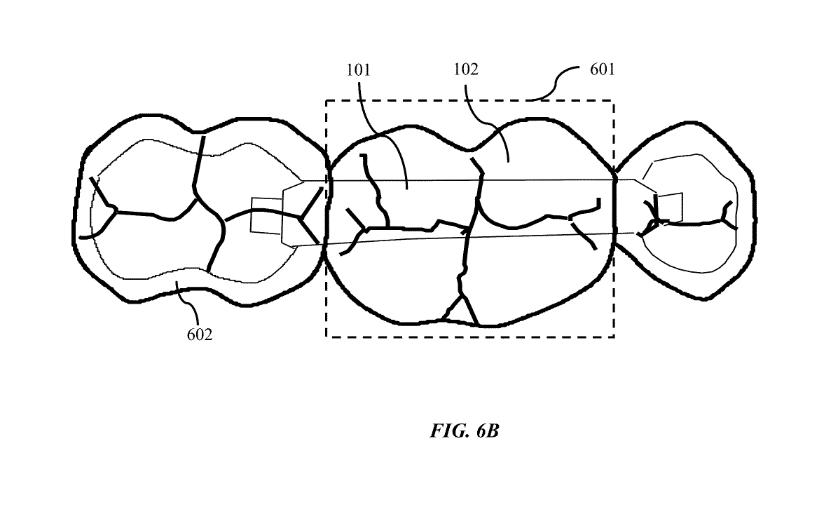

FIG. 5A and FIG. 5B illustrates a schematic view of an abutment tooth present around an edentulous area from occlusal view, according to an embodiment herein. FIG. 5C and FIG. 5D illustrates a schematic view of an abutment tooth present around an edentulous area from buccal view, according to an embodiment herein. The first step in dental restoration consists of the dentist reducing the adjacent abutment tooth 501. The number of abutment teeth 501 depends on the length of the bridge work. For conventional bridgework, the two adjacent teeth 501 next to the empty space is prepared to seat the crown and the pontic is placed in the middle, in order to ensure maximum support since the force is equally distributed to the neighboring teeth. The light shade outline 502 represents shape of the adjacent tooth before abutment tooth preparation. After reducing the abutment tooth 501, the axial walls of the tooth are maintained parallel to each other in-order to properly seat the bridge. Further a groove 503 is carved in the abutment tooth 501 so that an arm on the pontic is slipped into the abutment tooth 501. The groove 503 also has an extension 504 on occlusal area of the tooth. The extension 504 is provided in-order to hold the projection of the inner core of the bridgework.

FIG. 6A and FIG. 6B illustrates a perspective view of the bridgework constructed from the mill blank, according to an embodiment herein. FIG. 6A-6B show the final restoration of bridgework in the edentulous area of the patient's mouth. The entire mill blank is fabricated in the milling machine to produce pontic part 601 of the bridgework, whereas the surrounding outer cover 102 of the mill blank is carved to form the crown 602 of the bridgework. As shown in figure, the inner core 101 of pontic part 601 rest in the groove 503 of the abutment teeth 501, and the crown 602 is cemented onto the abutment teeth 501. The insertion of inner core 101 into groove 503 provides pressure resistance against occlusal force and support the pontic part 601 of the bridge.

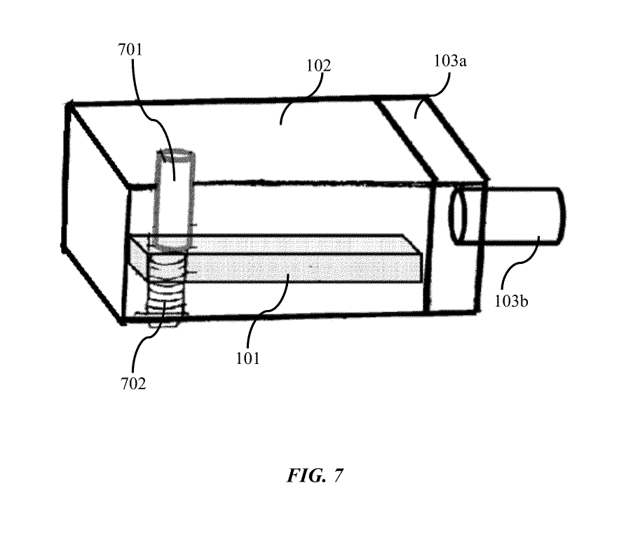

FIG. 7 illustrates a perspective view of the mill blank with a channel at one end of the blank, according to an embodiment of the present disclosure. The mill blank comprising a channel 701 enables a construction of a screw type bridgework for incorporating a multiple dental implant 702 in an edentulous area of mouth. The mill blank with built-in channel comprises the hard inner core 101, the surrounding outer cover 102, and the handle stud 103. The channel 701 passes through the surrounding cover 102 and the inner core 101. At one end of the channel 701, a preformed implant abutment 702 is attached to the bridgework by dentist or manufacturer, after milling. The screw type bridgework with multiple implant is designed on the computer in such a way that the first implant coincides with the milling blank channel, whereas the next implant coincides with the inner hard core and the prosthesis is milled on the implant. The next abutment metallic part is attached to the milled bridgework by the dentist.

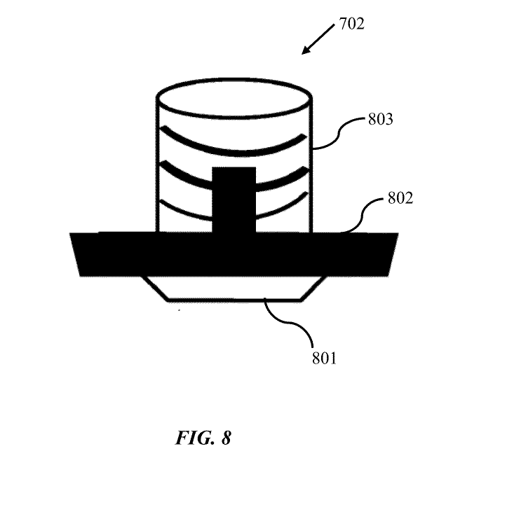

FIG. 8 illustrates a schematic view of a preformed implant abutment, according to an embodiment herein. The preformed implant abutment comprises a base 802, a connector part 801 and an abutment screw 803. The connection part 801 is a non engaging part provided to enable the screw tightening process for the abutment screw 803. The abutment screw 803 is an engaging part that fits in the channel of the mill blank.

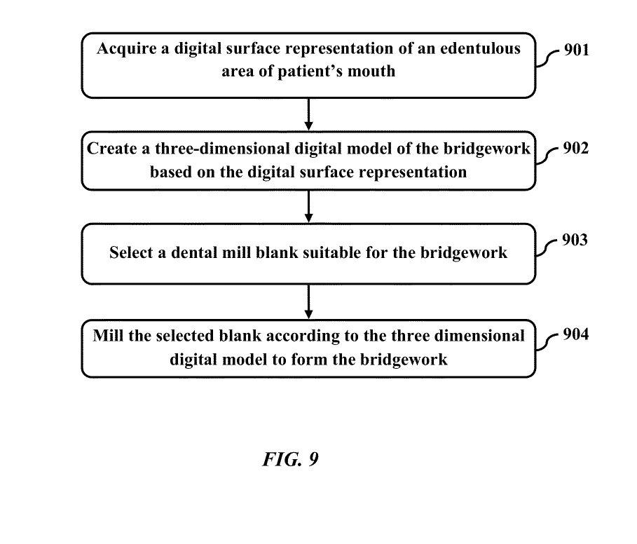

The various embodiments of the present disclosure disclose a method for fabricating the bridgework from the mill blank. FIG. 9 illustrates a flowchart indicating a method for fabricating the bridgework from the mill blank, according to an embodiment of the present disclosure. The fabrication method is carried out using CAD and CAM machine and the restoration is designed in a digital format. The method comprises the following steps. A digital surface representation of at least a portion of patient mouth comprising an edentulous area is acquired (901). Based on the digital surface representation of the edentulous area, a three-dimensional digital model of the bridgework is created (902). Further the dental mill blank suitable for the bridgework is selected (903). The bridgework is fabricated by milling the mill blank according to the three dimensional digital model (904).

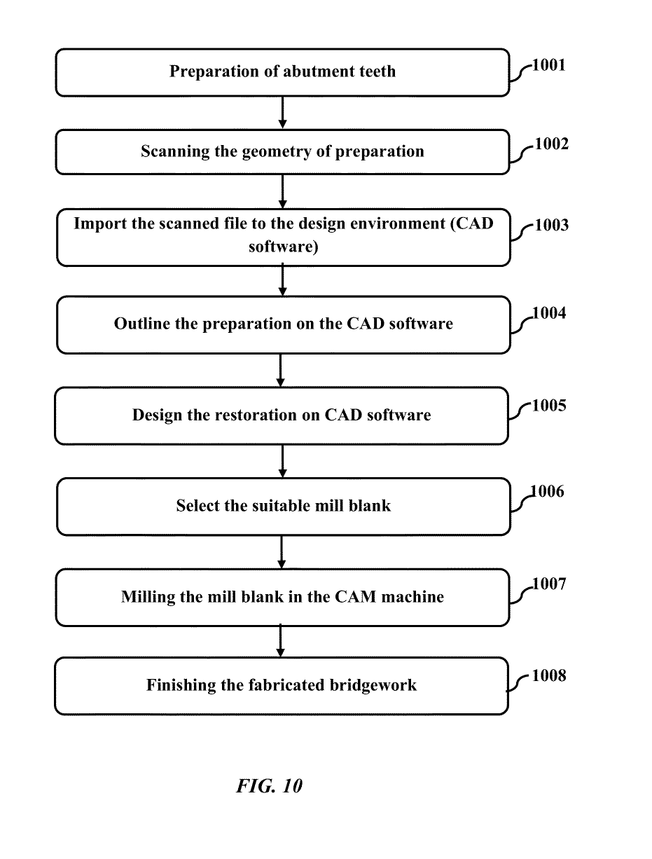

FIG. 10 illustrates a flowchart illustrating the detailed fabrication process of the bridgework, according to an embodiment herein. The process comprises the following steps: Initially the abutment teeth are prepared (1001). Further the geometry of abutment teeth preparation is scanned (1002). The prepared abutment teeth scanned to find out the best position and size possible to fit in the bridgework. According to the scanned results, the groove and extension of the abutment teeth is prepared. The prepared abutment teeth are again rescanned for evolution of teeth preparation. After final adjustment, the prepared adjacent and opposing teeth are digitally scanned. Further the soft tissue, the occlusion and at least a portion of the patient mouth at the location of treatment is scanned to form digital dental model. The scanned file is imported to the design environment (CAD software) (1003). The bridgework is designed in the CAD program, so that the inner hard core of milling blank digitally positioned in the pontic area. The outline of bridgework preparation is designed on the CAD software (1004). The important areas of the design are marked, which include but not limited to surface of prepared teeth, finish line, auxiliary wall and occlusal part. Further the unnecessary image and data around the prepared outline is trimmed away. A buffer/cement space is created around prepared teeth. The imaginary crown from the CAD library is conformed to the image of prepared teeth based on the type of teeth and measured height. The virtual bridgework is adjusted into the milling blank virtual shape. Finally, the complete restoration is designed on the CAD software (1005). The CAD software outputs a file for design of the bridgework and the file is send to milling unit. A suitable mill blank is selected which is used to manufacture the bridgework (1006). Primarily a preoperative condition and passivity of fabricating the bridgework is assessed. The practicability of fabrication depends on angulations and distance of abutment teeth. The judgment on practicability is estimated by calculating the condition via intra-oral scanning, or manually by connector key or hard core gauge. If the restoration is achievable, the milling blank is chosen. The file generated by the CAD software is mounted in the CAM machine (1007). The milling blank inserted into the milling machine. The machine mills the blank to output the restoration. Finally, finishing is provided to the fabricated bridgework (1008). The milled restoration is sintered, cures or hardens on the basis of surrounding materials are colored, polished or glazed if needed. The finished restoration is cemented on the abutment teeth. The CAD software maps the designed bridgework model onto the middle of milling blank geometry. The software measures an outline of the virtual design and generates a notification when the bridgework model does not fit in to the geometry of blank.

In this procedure, after designing the dental restoration in CAD area, the software superimposed the virtual model designed in the middle of milling blank geometry. The software measures the outline of virtual design and warns when the design is not fit in to the geometry of blank. Afterwards the suitable blank mounted in the milling machine (CAM) and the machine mill the blank with bur so that the additional material is removed to convert the geometry of blank convert and the blank is modified to build the required dental bridgework.

The foregoing description of the specific embodiments herein will so fully reveal the general nature of the embodiments herein that others can, by applying current knowledge, readily modify and/or adapt for various applications such specific embodiments herein without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

What is claimed is:

1. A dental mill blank for fabrication of dental appliance and restorations comprises:
hard inner core, wherein the hard inner core provides resistance against a normal occlusal force;
soft outer cover surrounding the hard inner core;
a handle stud for holding the mill blank onto a milling machine.

2. The dental mill blank according to claim 1, wherein the hard inner core has a surface provided with a surface bonding profile for establishing a connection between the inner core and the outer cover.

3. The dental mill blank according to claim 1, wherein the hard inner core is designed in a plurality of shapes of cross sections and sizes, and wherein a shape of the hard inner core is selected from a group consisting of a square, rectangular, triangular, rhomboidal, ovoid, cylindrical or irregular shape.

4. The dental mill blank according to claim 1, wherein the hard inner core has an outline designed in a shape selected from a group consisting of a curve shape, bead shape, rectangular shape or irregular in shape.

5. The dental milling blank according to claim 1, wherein the hard inner core has a projection at each end, and wherein the projection resides inside an occlusal extension of the proximal boxes of an abutment teeth.

6. The dental mill blank according to claim 1, wherein the hard inner core is extended along a length of the mill blank.

7. The dental mill blank according to claim 1, wherein the hard inner core is manufactured from high strength materials selected from a group consisting of ceramic, zirconium, yttrium stabilized zircon, alumina, mixture of alumina and zirconium, or metal and metal alloys.

8. The dental mill blank according to claim 1, wherein the surrounding soft outer cover is manufactured from a group of materials comprising feldspathic porcelain, glass porcelain, glass ceramic, acrylic or composite materials.

9. The dental mill blank according to claim 1, wherein the surrounding soft outer cover material is made up of sintered materials.

10. The dental mill blank according to claim 1, wherein the surrounding soft outer cover material is made up of a green or pre-sintered materials and wherein the green material is hardened after a milling process.

11. The dental mill blank according to claim 1, wherein the hard inner core and the soft outer cover material comprise a plurality of layers.

12. The dental mill blank according to claim 1, wherein the surrounding outer cover material of the mill blank is designed to form a crown of the bridgework after a milling process, wherein the crown is cemented on an abutment tooth.

13. The dental mill blank according to claim 1, wherein said dental mill blank is applied to an implant bridge, wherein said mill blank further comprises a channel passing through the hard inner core and the Soft outer cover, and wherein a preformed implant abutment is provided at one end of the channel wherein said preformed implant abutment comprises a connection part, a base and a retentive part, which the connection part is compatible with fixture heads.

14. The dental mill blank according to claim 13, wherein the blank is designed to make screw type bridgework for supporting a plurality of adjacent implants.

15. A method for fabricating a dental bridgework from a mill blank comprising steps of:
acquiring a digital surface representation of at least a portion of patient mouth comprising an edentulous area and adjacent prepared teeth, and wherein the digital surface representation is acquired by scanning the geometry of the edentulous area of patient's mouth;
creating a three-dimensional digital model of a bridgework from the digital surface representation, and wherein the digital model of the bridgework is designed from the digital surface representation using a CAD software;
selecting a dental mill blank suitable for the bridgework;
forming the bridgework by milling the mill blank physically in CAM machine according to the three dimensional digital model, wherein a hard inner core physically placed at the joint area of the bridgework and wherein said bridgework is cemented on said prepared teeth.

16. The method according to claim 15, wherein the step of selecting the mill blank depends on a preoperative condition of the edentulous area, adjacent teeth, mill blank and passivity of constructing the bridgework.

17. The method according to claim 16, wherein the step selecting of the mill blank is calculated via intraoral scanning or is manually calculated using a connector key or a hard core gauge.

18. The method according to claim 15, wherein preparation of the abutment teeth for bridgework is carried out by help of hard core gauge until the abutment teeth is correctly prepared.
